(19) United States
(12) Patent Application Publication
(10) Pub. No.: US 2005/0226975 A1
(43) Pub. Date: Oct. 13, 2005

(54) Foodstuff marking system

(76) Inventor: Greg Drouillard, Peachtree City, GA (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/822,934

(22) Filed: Apr. 13, 2004

(51) Int. Cl. A23P 1/00

(52) U.S. Cl. 426/383

(57) ABSTRACT

An apparatus for marking a foodstuff with a mark and the method of effecting same are disclosed. An ink free apparatus, which can be a laser or a printer head, is used to etch a mark on a foodstuff. A spray gun is used to spray a food grade coloring over the etched mark.

### BACKGROUND OF THE INVENTION

This invention is generally directed to an apparatus and method for marking foodstuffs, such as fruits, vegetables, eggs, meat and the like, with identifying marks using initially ink free techniques and thereafter using a spraying station to spray a food grade coloring over the mark to provide additional contrast from the remainder of the foodstuff.

The Grocers Association requires that a number, called a price look-up (“P.L.U.”) number, is put on produce, especially citrus fruits, and some types of vegetables which are sold in a loose state, as opposed to bagged or plastic-wrapped produce. The Grocers Association requires this number so it can merchandise different sizes and types. The P.L.U. number represents different varieties, sizes (normally two; large, small) and geographic growing areas within the United States. Further labeling may be undertaken by an individual packer to identify brand names or specific growing region, for example, Indian River grapefruit, Vidalia onion. Some states mandate that the “country of origin” be noted, for example, tomatoes from Mexico, apples from Chile. The P.L.U. marking requirement is not limited to the United States.

P.L.U. numbers allow a check-out clerk to identify the items of produce quickly and easily. A store may have the P.L.U. numbers and the associated identifying data entered into a computer. To access the data, the clerk need only read the number on the produce and enter it into the computer.

Prior to the usage of P.L.U. numbers, grocers often lost money from giveaways that resulted from mixed sizes or types of produce. The check-out clerk was always told to err on the side of the customer. This mispricing happened often which resulted in large losses for the grocery stores. The P.L.U. number aids the check-out clerk from mispricing the produce that looks the same but has a different quality value. This minimizes loss of money to a grocer due to “giveaways” that result from mixed sizes or types, and minimizes time at the check-out counter which have previously resulted from price checks. The usage of the P.L.U. numbers also aids in inventory control which previously had been a problem area.

U.S. Pat. Nos. 5,660,747 and 5,897,797 discloses three ink free techniques for creating a mark on a foodstuff. The first ink free technique uses a laser to etch the foodstuff to form the mark. The second and third ink free techniques use a printer head, with the exception that an ink ribbon is not used. In the second ink free technique, the pins of the printer head impact the foodstuff thereby etching the foodstuff to form the identifying mark. In the third ink free technique, a thermally conductive ribbon member is placed between the printer head and the foodstuff. The pins of the printer head impact the ribbon member thereby forming a hot spot on the ribbon member, which in turn, etches the foodstuff to form the identifying mark. With any of these ink free techniques, the mark is produced by vaporizing a portion of the foodstuff. In fruits and vegetables, the skin of the fruit or vegetable is desiccated at the point where the laser light beam, the pins or the ribbon contacts the skin, at a sufficiently high energy level to cause surface vaporization, yet limited in time duration to prevent transfer of heat energy to the underlying tissues of the fruit or vegetable, subsequently preventing thermal degradation or breakdown of these tissues.

As further discussed in U.S. Pat. Nos. 5,660,747 and 5,897,797, a swabbing station is provided to swab food grade coloring on the foodstuff over the mark to provide a visually enhanced contrast between the mark and the remainder of the foodstuff. The food grade coloring is nontoxic and is used widely for coloring of foodstuffs. After the foodstuff, for example a citrus fruit, is etched with the mark, the marked foodstuff passes under an application pad, a sponge, that has been soaked with a food grade coloring to swab the surface of the foodstuff around the mark.

The swabbing station while functional, has been found to have short comings, particularly in the produce industry. Since the original provision of the swabbing station described in U.S. Pat. Nos. 5,660,747 and 5,897,797, significant advances have been made in the conveying equipment industry with which the swabbing station could not be engineered or redesigned to adapt to the advances in the conveyors. Conveyors have advanced in the areas of conveying speed and electronic sizing technology which made the swabbing station described in U.S. Pat. Nos. 5,660,747 and 5,897,797 obsolete. Also, the swabbing station described in U.S. Pat. Nos. 5,660,747 and 5,897,797 cannot be electronically controlled or programmed; this is required in order to selectively and precisely apply the food grade coloring over the mark. Originally, when the swabbing station was designed, the conveyors worked at a maximum speed of 5 to 6 cps (cups per second). Conveyors now routinely run at 8 to 14 cps. The continual development and updates to the laser has enabled the laser to keep pace with this speed, but the swabbing station could not.

The piece of produce is placed in a cup (this could also be a roller but it is called a cup, this term is universally known and used in the agriculture product conveying business) and moved down the conveyor line. When the conveyor line speed is increased to and over 6 cps, the swabbing applicator arm tends to bounce off the piece of produce and skip over the next piece of produce. When the tension on the swabbing arm is increased to overcome this bouncing, the swabbing arm resists rising up and over the piece of produce, which in turn causes the piece of produce to be pushed backwards and into the following cup, which if there is a piece of produce in this cup, a chain reaction of produce being forced backwards is caused. This is called migration in the conveyor industry. The negative effect of this migration is that the produce's position is lost with respect to the position the electronic sizer had recorded and stored, that is, the stored reference of that produce has not changed from the original location when the produce was analyzed, and since this location cannot be updated with the new location (due to migration), this results in an incorrectly processed piece of produce.

In addition, all the produce on the conveyor is swabbed regardless of whether the produce had been marked. This is a waste of food grade coloring on produce that has not been marked; it also leaves an undesirable appearance on the produce from the produce packer's point of view. The produce packer requires that only the marked produce have the food grade coloring enhancement applied to the mark. There are times when a specific size, weight, color, etc., is needed solely for bagging, and this bagged produce does not require individual labeling but is processed at the same time on the same packing line as individually sold pieces which require labeling.

The swabbing station is not accurate, which is a requirement, in that the swabbing station cannot be controlled in such a way as to start applying the food grade coloring at the beginning of the mark and stop at the end of the mark. The applicator of the swabbing station had to be designed large enough to cover the longest and largest possible mark that can be printed, and because of this, there is a large difference between the largest possible mark and the smallest mark, which results in a large colored area if the mark is small. This is very inefficient and the swabbing station cannot be changed in real time to accommodate these differences, which results in a waste of food grade coloring, and an undesirable appearance.

In addition, there can also be a problem with not cleaning or improper cleaning of the application pad which contacts the produce to apply the food grade coloring over the mark. Cleaning the application pad must be properly done to prevent plugging from wax buildup and also, most importantly that it does not transfer decay organisms from one produce to another. Monitoring the application pad is required, and must be done regularly. The produce is waxed as a normal part of the process. Waxing is effected before the mark is etched. The wax tends to be tacky and because the application pad contacts the produce, the wax slowly builds up on the application pad which prevents application pad from operating properly and efficiently. This results in the requirement of frequent changing and cleaning of the application pad. The other problem that arose was improper cleaning methods. If the applicator pad is not properly cleaned, bacterial and or fungal growth may arise. This could possibly spread the decay to each produce which contacts the application pad. As a result, the swabbing station requires much more care and maintenance that was acceptable to the customer.

Another prior art method of marking produce was to directly mark foodstuffs with an ink jet printer using edible ink. This type of marking system, however, requires use of an ink (water soluble FDA approved ink) which is not sufficiently permanent and smudges. In fruits and vegetables, food grade ink sweats off because of the wax applied to produce or because of the produce's natural wax. The sweat cycle is the cycle the fruit or vegetable goes through when it is stored and shipped to market. The fruit or vegetable is put into a cooler with high humidity for preservation. When the fruit or vegetable is taken out of this environment, it sweats and the moisture lifts the water soluble ink off the surface of the fruit or vegetable.

The present invention provides an apparatus and method of marking foodstuffs which overcomes the problems presented in the prior art and which provides additional advantages over the prior art. Such advantages will become clear upon a reading of the attached specification in combination with a study of the drawings.

### OBJECTS AND SUMMARY OF THE INVENTION

A general object of the present invention is to provide an apparatus and method of marking a foodstuff using food grade coloring over an etched mark formed on the foodstuff.

An object of the present invention is to provide an apparatus and method of marking a foodstuff with food grade coloring which can be electronically controlled or programmed to selectively and precisely apply the food grade coloring over the mark.

Yet another object of the present invention is to provide an apparatus and method of marking a foodstuff with food grade coloring which prevents migration of the foodstuff in the conveyer line.

A further object of the present invention is to provide an apparatus and method of marking a foodstuff with food grade coloring in which only the marked foodstuff are sprayed with food grade coloring.

Yet a further object of the present invention is to provide an apparatus and method of marking a foodstuff with food grade coloring in which the spraying of the food grade coloring can be controlled so as to start applying the food grade coloring at the beginning of the mark and stopping at the end of the mark.

Another object of the present invention is to provide an apparatus and method of marking a foodstuff with food grade coloring which can be changed in real time to accommodate changes in the marks applied to the foodstuff.

Yet a further object of the present invention is to provide an apparatus and method of marking a foodstuff with food grade coloring that it does not transfer decay organisms from one foodstuff to another.

Briefly, and in accordance with the foregoing, the present invention discloses an apparatus for marking a foodstuff with a mark and the method of effecting same.

An ink free apparatus, which can be a laser or a printer head, is used to etch a mark on the foodstuff. A spray gun is used to spray a food grade coloring over the etched mark.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a schematic diagram of the foodstuff marking system which incorporates the features of the present invention;

FIG. 2 is an elevational view of a foodstuff, shown as an orange, which has been marked with an identifying mark made by the foodstuff marking system;

FIG. 3 is an elevational view of a foodstuff, shown as an orange, which has been marked with a different identifying mark made by the foodstuff marking system;

FIG. 4 is a cross-sectional view of a cup holding a foodstuff, shown as an orange, and a side elevational view of a laser head which can be used in the foodstuff marking system of the present invention;

FIG. 5 is an elevational view of a foodstuff, shown as an orange, and a cross-sectional view of a printer head which can be used in the foodstuff marking system of the present invention;

FIG. 6 is an elevational view of a foodstuff, shown as an orange, and a cross-sectional view of a printer head and ribbon which can be used in the foodstuff marking system of the present invention;

FIG. 7 is a perspective view of a spray gun which is used in the foodstuff marking system of the present invention; and

FIG. 8 is an exploded perspective view of a spray head of the spray gun of FIG. 7.

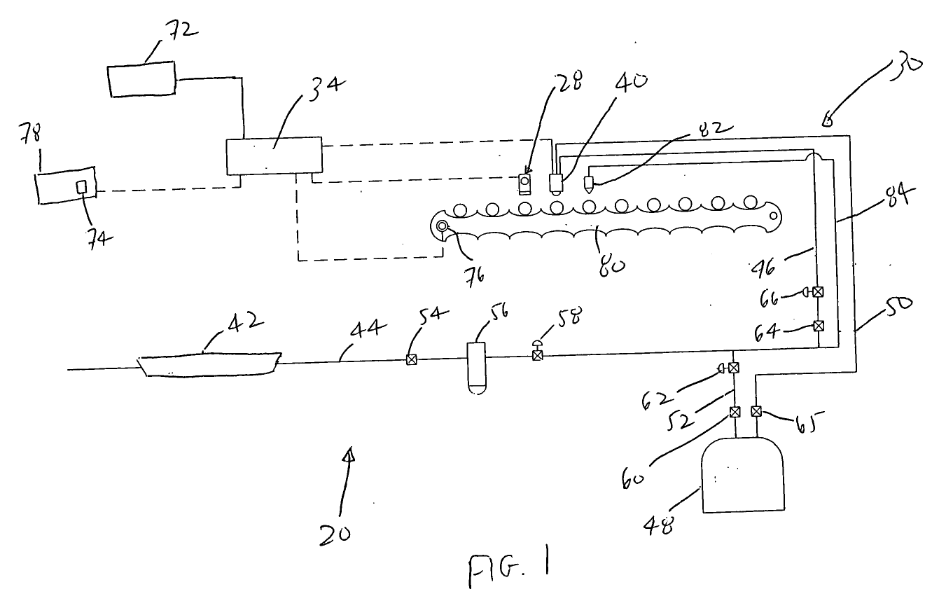

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

The foodstuff marking system 20 etches a foodstuff 24 with a mark 26, and thereafter enhances the contrast between the mark 26 and the remainder of the foodstuff 24 by using food grade coloring. The etched mark 26 is made using a marking apparatus 28, which uses an initially ink free technique, such as those disclosed in U.S. Pat. Nos. 5,660,747 and 5,897,797, which disclosures are herein incorporated by reference. By using the term ink free, this means that ink, edible or inedible, is not used in the initial process to mark the foodstuff 24. A spraying station 30 is provided to apply the food grade coloring, such as FD&C Red #40, FD&C Red #1 or FD&C Blue #1, over the etched mark 26 to provide additional contrast from the remainder of the foodstuff 24. The food grade coloring is nontoxic and is used widely for coloring of foods. The foodstuff marking system 20 can be used to mark a variety of foodstuffs, such as fruits, vegetables, eggs, meat and the like.

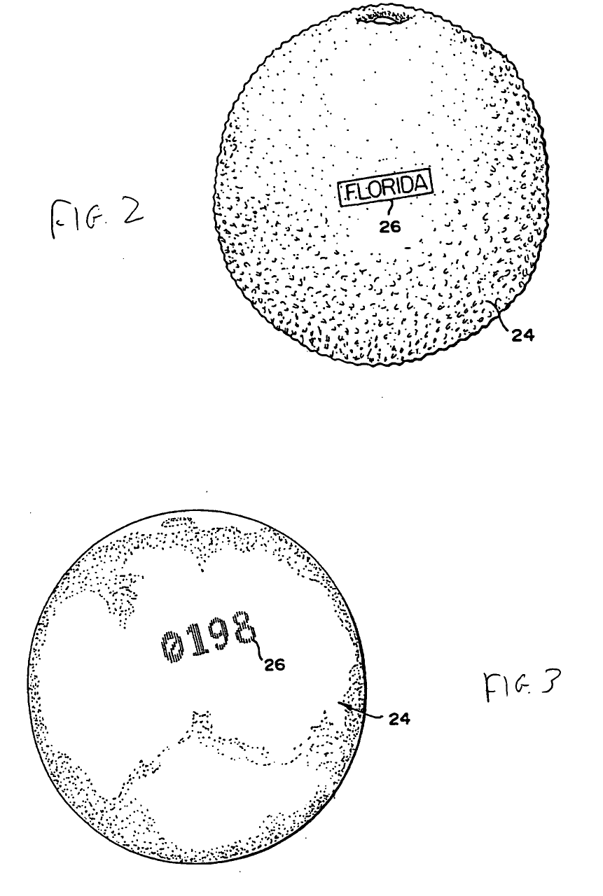

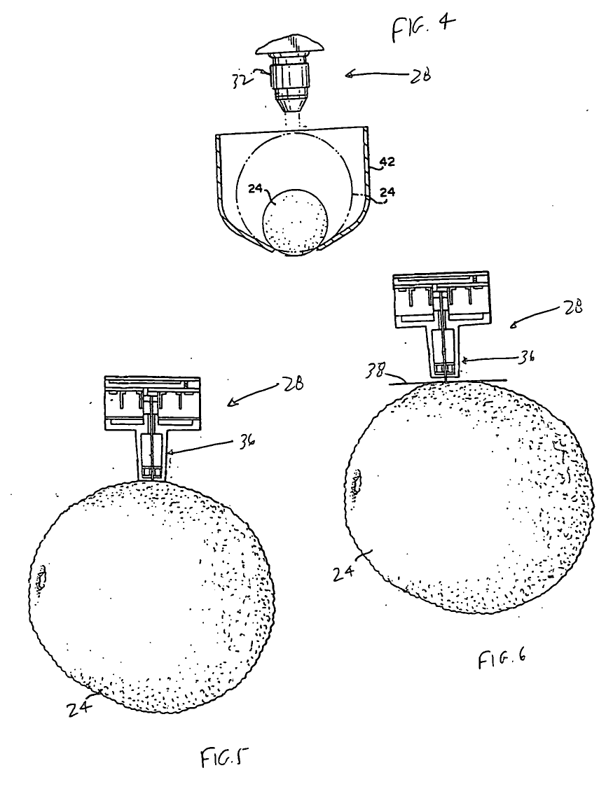

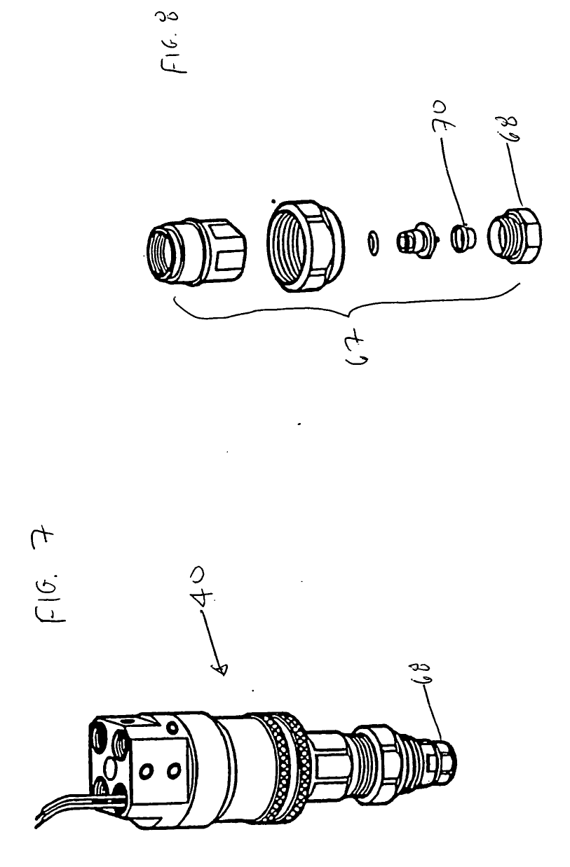

The foodstuff 24 can be marked with a variety of marks 26, such as numbers, letters or a bar code. For example, the foodstuff 24 can be marked with the word “FLORIDA” surrounded by a rectangular box, as shown in FIG. 2, with the P.L.U. number, as shown in FIG. 3, or with a brand name identification. For example, a banana bearing the marked brand name of, for example, CHIQUITA®, DEL MONTE®, DOLE® or TURBANA® bananas. Another example is that an egg can be marked with an expiration date.

A marking apparatus 28 disclosed in U.S. Pat. Nos. 5,660,747 and 5,897,797 uses a laser 32, see FIG. 4. The laser 32 is a sterile, non-contact, high speed, efficient method of marking a foodstuff 24 and provides a sharply defined, permanent mark 26 on the foodstuff 24, such as a P.L.U. identification number or other informational characters for recognition by processors, sellers and purchasers of the foodstuff. The laser 32 is controlled by a programmable electronic interface 34, which is a high speed programmable logic controller (PLC). The laser 32 uses a high intensity light beam 30 to etch the foodstuff 24 to form the mark 26. In fruits and vegetables, the mark 26 is produced by vaporizing a portion of the skin of the fruit or vegetable to desiccate the skin at the point where the light beam 30 contacts the skin, at a sufficiently high energy level to cause surface vaporization, yet limited in time duration to prevent transfer of heat energy to the underlying tissues of the fruit or vegetable, subsequently preventing thermal degradation or breakdown of these tissues. In eggs, the mark 26 is produced by vaporizing a portion of the shell at the point where the light beam 30 contacts the shell, at a sufficiently high energy level to cause vaporization, yet limited in time duration to prevent transfer of heat energy to the underlying yolk of the egg, subsequently preventing thermal degradation or breakdown of the yolk. In meat, the mark 26 is produced by vaporizing a portion of the surface of the meat to at the point where the light beam 30 contacts the surface, at a sufficiently high energy level to cause surface vaporization, yet limited in time duration to prevent transfer of heat energy to the underlying tissues of the meat, subsequently preventing thermal degradation or breakdown of these tissues.

A second marking apparatus and a third marking apparatus 28 disclosed in U.S. Pat. Nos. 5,660,747 and 5,897,797 use a printer head 36, with the exception that an ink ribbon is not used. In the second marking apparatus 28 disclosed in U.S. Pat. Nos. 5,660,747 and 5,897,797, the pins of the printer head 36 impact the foodstuff 24 thereby etching the foodstuff 24 to form the mark 26. In the third marking apparatus 28 disclosed in U.S. Pat. Nos. 5,660,747 and 5,897,797, a thermally conductive ribbon member 38 is placed between the printer head 36 and the foodstuff 24. The pins of the printer head 36 impact the ribbon member 38 thereby forming a hot spot on the ribbon member 38, which in turn, etches the foodstuff 24 to form the mark 26. The printer head 36 is controlled by a programmable electronic interface 34, which is a high speed programmable logic controller (PLC). For fruits and vegetables, the mark 26 is produced by vaporizing a portion of the skin of the fruit or vegetable to desiccate the skin at the point where the pins or the ribbon 38 contacts the skin, at a sufficiently high energy level to cause surface vaporization, yet limited in time duration to prevent transfer of heat energy to the underlying tissues of the fruit or vegetable, subsequently preventing thermal degradation or breakdown of these tissues. In eggs, the mark 26 is produced by vaporizing a portion of the shell at the point where the light beam 30 contacts the shell, at a sufficiently high energy level to cause vaporization, yet limited in time duration to prevent transfer of heat energy to the underlying yolk of the egg, subsequently preventing thermal degradation or breakdown of the yolk. In meat, the mark 26 is produced by vaporizing a portion of the surface of the meat to at the point where the light beam 30 contacts the surface, at a sufficiently high energy level to cause surface vaporization, yet limited in time duration to prevent transfer of heat energy to the underlying tissues of the meat, subsequently preventing thermal degradation or breakdown of these tissues.

The spraying station 30 includes a high speed, air atomizing, low volume spray gun 40 which has a source of compressed air 42 connected thereto by a line 44, 46, and a fluid reservoir 48 connected thereto by a line 50. The fluid reservoir 48 is also connected by line 52 to the line 44, 46. A block valve 54, an air dryer/filter 56 and an air pressure regulator 58 are provided along line 44 between the source of compressed air 42 and the line 52 from the fluid reservoir 48. A block valve 60 and a air pressure regulator 62 are provided along line 52 between the fluid reservoir 48 and line 44, 46 from the source of compressed air 42 to the spray gun 40. A block valve 64 and an air pressure regulator 66 are provided along line 46. A block valve 65 is provided along line 50. The spraying station 30 is controlled by the PLC 34.

A suitable spray gun is the Model 28JJAU-1/8 Compact Auto Jet spray gun which is manufactured by Spraying Systems Co. located in Wheaton, Ill. The spray gun 40 has a spray head 67 which includes a fluid cap 68 and an air cap 70 to achieve the desired liquid volume of spray and the pattern. The fluid cap 68, in combination with compressed air, controls the liquid volume. During testing, fluid caps 68 ranging in sizes of 8000th to 14500th of an inch have been used. The air cap 70 controls the spray pattern. The air cap 70 comes in many different configurations to produce many spray patterns such as, for example, circular, square, rectangular and a single line pattern. The spray gun 40 has a continuous duty rate of up to 2000 cycles per minute. The spray gun 40 requires 24vdc at 0.5 amps from a suitable source, and compressed air for the atomization of the liquid to be sprayed.

The spray gun 40 is positioned a predetermined distance, preferably 3″ to 6″, away from the foodstuff 24 such that the spray gun 40 does not contact the foodstuff 24. Because the spray gun 40 does not contact the foodstuff 24, migration along the conveyor line is eliminated; the spray gun 40 is not plugged up from wax buildup from the foodstuff 24 if fruits or vegetables are being marked; and food safety is improved because decay organisms are not transferred from one foodstuff 24 to another by the spray gun 40.

The spray gun 40 is electronically controlled by the PLC 34 which allows precise application control of the food grade coloring to the mark 26, without excessive over-coverage. The PLC 34 has suitable programming to start applying the color at the beginning of the mark 26 and to stop at the end of the mark 26. Also, the spray timing is adjusted automatically by the PLC 34, based on the size of the mark 26 and the line speed of the conveyor. The spraying station 30 is designed to react and adjust to any changes of the marking in real time.

The PLC 34 can automatically and instantly adjust the spray gun 40 for the differing conveyor line speeds without interruption. The spray gun 40 is capable of operating at very low line speeds, including zero, to very high speeds (the present range is 0 cups per second (cps) to 14 cps, however, the spray gun 40 is capable of going much faster). The spray gun 40 is accurate, has adjustable spray patterns for optimal coverage, is dependable, has very low operational maintenance, and has a long operational service life.

To start, the user inputs the desired code and system parameters using a keypad and display 72 which is connected to the PLC 34. With the user's input of the desired code to be printed, the PLC 34 uses this input and the input from the attached external sensors to make the necessary calculations and adjustments for the marking apparatus to operate properly. As shown, the PLC 34 has two external inputs, a product sensor 74 and a shaft encoder 76. The product sensor 74 determines if there is a foodstuff 24 present to mark. A send and receive infrared beam switch can be used for the product sensor 74 and is sent by a sizer 78. The shaft encoder 76 is a sensor that is mounted on the conveyor 80 on which the foodstuff 24 is being conveyed. The shaft encoder 76 records the line speed and outputs a signal that is used by the PLC 34 for timing purposes. Use of the keypad and display 72, the product sensor 74 and the shaft encoder 76 and their interaction with the controller (PLC 34) is further described in U.S. Pat. Nos. 5,660,747 and 5,897,797 which have been incorporated by reference. If the laser 32 is being used as the marking apparatus, a safety interlock as discussed in U.S. Pat. Nos. 5,660,747 and 5,897,797 which have been incorporated by reference is provided and is additionally connected to the PLC 34. In addition, it is to be noted that in U.S. Pat. Nos. 5,660,747 and 5,897,797, the PLC 34 is defined as the control electronics board (CEB) and includes an input from the remote scanning head and additional circuitry. This is applicable to the present invention if the laser 32 is used as the marking apparatus.

To mark the foodstuff 24, the foodstuff 24 is transported from the sizer 78, a sorting mechanism well known in the art, on the conveyor 80 to the marking apparatus 28. Conveyors can be manufactured as a one lane machine to many lanes, so it can be termed as a one lane sizer or an eight lane sizer, etc. There are also many cup designs (the cup is what the foodstuff 24 sits in on the conveyor 80, this could be a roller but it is called a cup, this term is universally known and used in the agriculture product conveying business); the size of the cup determines the pitch (the size of the cup can range from 3″, 3.25″, 3.5″, 3.75″, 4.0″ etc., this depends on the foodstuff to be conveyed and is usually not, but can be, changed out once built and if the pitch is 3.5″ then a conveyor running at 8 cps would translate to a linear line speed of 140 feet per minute (fpm) but if the pitch were 4.0″ and 8 cps the line speed would be 160 fpm). After the sizer 78 processes the foodstuff 24, a signal from the shaft encoder 76 regarding the line speed is input to the PLC 34. Once the PLC 34 determines that the foodstuff 24 is under the marking apparatus 28, the PLC 34 sends a signal to the marking apparatus 28 to etch the desired mark 26 on the foodstuff 24. In fruits and vegetables, the marking apparatus 28 produces an off-white to light tan residual marking on the fruit or vegetable as a result of the desiccation. Next, the foodstuff 24 is transported to the spraying station 30 by the conveyor 80. Once the PLC 34 determines that the foodstuff 24 is under the spray gun 40, the PLC 34 sends a signal to the spraying station 30 to spray the food coloring over the etched mark 26. Air is supplied from the source of compressed air 42, along line 44, through block valve 54, air dryer/filter 56 and air pressure regulator 58, along line 46, through block valve 64, air pressure regulator 66 to the spray head 40. Air also flows along line 52, through air pressure regulator 62, through block valve 60 and into the fluid reservoir 48. The air supplied to the fluid reservoir 48 creates a head pressure on the fluid which controls the amount of fluid that is supplied to the spray gun 40 and then applied to the foodstuff 24. The fluid from the fluid reservoir 48 flows along line 50, through block valve 65 to the spray gun 40. The air supplied to the spray gun is 40 atomizes the fluid. The atomizing aids in (and is required to accomplish proper application coverage of color onto the foodstuff 24) doing three things: first, atomizing provides an overall and consistent spray coverage and pattern; second, atomizing the fluid allows for less liquid to be used on each application—atomizing reduces the droplet size so that not as much fluid needs to be applied to give an even coverage; and third atomizing aids in delivery of the fluid to the foodstuff 24 over the required distance without losing the pattern—this essentially gives the (very small droplets) droplets inertia and momentum. If the PLC 34 determines that no mark is to be made on the foodstuff 24 (the user chooses that no mark is to be made and inputs same into the keyboard and display 72), the marking apparatus 28 and spray gun 40 are not activated by the PLC 34. Thereafter, the foodstuff 24 is collected for distribution. A marking apparatus 28 and a spraying station 30 are provided for each line of foodstuff 24. The block valves 54, 60, 64 and 65 are used to prevent fluid flow when the fluid reservoir 48 needs to be taken out of service to be cleaned, filled, changed with another tank that has a different color, etc.

The spray gun 40 is compact and the spray head 67 is accurate in directing the food grade coloring onto the mark 26. As a result, the spray gun 40 can be placed close to the marking apparatus 28, a distance which is between a minimum of one cup or 3.5″ to a maximum of two cups or 7″. Because the spraying of the food grade coloring is effected shortly after the mark 26 is etched, this aids in the food grade coloring being absorbed completely before the abscission layer closes. The optimal application window for applying the food grade coloring to the mark 26 is immediately after and up to 500 milliseconds (ms) after the mark 26 has been etched. If there is too long of a delay applying the food grade coloring after etching the mark 26, the food grade coloring will not be uniformly absorbed because the cauterized abscission layer will be closed or closing (then the food grade coloring then can be rubbed off or it can sweat off depending on the type of foodstuff being marked).

In the spraying station 30, the food grade coloring is sprayed over the mark 26 to produce a high color contrast between the mark 26 and the remainder of the exterior surface of the foodstuff 24. The food coloring is quickly absorbed into the foodstuff tissue and enhances the color contrast noticeably between the mark 26 and the remainder of the exterior surface of the foodstuff 24. To further protect against any spoilage of the foodstuff 24, the food grade coloring can have TBZ fungicide added therein.

The PLC 34 signals the spraying station 30 to fire the spray gun 40 only after the PLC 34 has instructed the marking apparatus 28 to etch the mark 26 onto the foodstuff 24. The spray location is determined along with the spray timing based on line speed and the code length of the mark 26. The PLC 34 is programed to control the centering of the mark 26 on the foodstuff 24 by the marking apparatus 28. The PLC 34 determines the starting location and the ending location of the mark 26 based upon line speed. The PLC 34 uses information to precisely fire the spray gun 40 and keep the spray gun 40 firing until the length of the mark 26 has been covered with the food grade coloring. With any line speed change detected by the shaft encoder 76, the PLC 34 has been preprogrammed to adjust the triggering signal to the spray gun 40. As an example, if the conveyor line speed is moving at a rate of 150 fpm and then it was slowed to 50 fpm, the PLC 34 would automatically calculate and adjust the triggering of the spray gun 40. Once the spray gun 40 is triggered, the spray gun 40 would need to stay on for a longer period of time due to the slower line speed so that the entire mark 26 is covered. Another example is that if the conveyor line speed is increased to 200 fpm and the diameter of the foodstuff 24 is 4″, the PLC 34 determines that only 250 ms will transpire before the foodstuff 24 passes a point along the conveyor line. If the mark 26 is only 1″ long, then the spray gun 40 would need to be triggered (sooner) at the correct time and left on (less time) for approximately 65 ms to fully cover the 1″ long mark 26. If the conveyor line speed was slowed to have the original speed to 100 fpm, then the PLC 34 would determine that it would take 500 ms for the foodstuff 24 to pass, and, in turn, there would be a longer delay before the spray gun 40 was triggered and the on-time for spraying the mark 26 would be longer, for approximately 125 ms. Accordingly, the foodstuff marking system 20 is capable of detecting line speed changes and adjusts the control parameters appropriately. The sizer 78 does not have to be electronic for the spraying station 30 to work. The only difference is that the signal passed to the PLC 34 is generated.

When a new batch of foodstuff 24 is ready to be marked, to alter the type of mark 26, the operator only needs to punch in the correct commands into the keyboard and display 72 to tell the PLC 34 to alter the mark 26 being made by the marking apparatus 28. If new marks are to be placed on the foodstuff 24, the PLC 34 only needs to be appropriately programmed to generate the new marks.

In addition, an air knife 82 can be provided. The air knife 82 is positioned after the spray gun 40. The air knife 82 is fed air by a line 84 from the source of compressed air 42. Air flows from the supplied from the source of compressed air 42, along line 44, through block valve 54, air dryer/filter 56 and air pressure regulator 58, along line 84 to the air knife 82. The air knife 82 is used to blow off the excess food grade coloring deposited on the foodstuff 24 and to aid the drying process of the food grade coloring.

While a preferred embodiment of the present invention is shown and described, it is envisioned that those skilled in the art may devise various modifications of the present invention without departing from the spirit and scope of the appended claims.

1. An apparatus for marking a foodstuff with a mark comprising:
an ink free apparatus for etching a mark on a foodstuff; and
a spray gun for spraying a food grade coloring over the etched mark.

2. An apparatus as defined in claim 1, further including a controller for controlling the operation of said spray gun.

3. An apparatus as defined in claim 2, wherein said controller also controls the operation of said ink free apparatus.

4. An apparatus as defined in claim 3, further including a conveyor for conveying the foodstuff past said spray gun.

5. An apparatus as defined in claim 4, wherein said conveyor also conveys the foodstuff past said ink free apparatus.

6. An apparatus as defined in claim 4, wherein said conveyor is capable of moving at variable speeds.

7. An apparatus as defined in claim 4, further including a shaft encoder associated with said conveyor for recording the speed of said conveyor and outputting a signal to said controller regarding the speed of said conveyor.

8. An apparatus as defined in claim 1, wherein said spray gun is spaced from the foodstuff a predetermined distance.

9. An apparatus as defined in claim 5, wherein said predetermined distance is a minimum of three inches to a maximum of seven inches.

10. An apparatus as defined in claim 1, wherein said spray gun is spaced from said ink free apparatus by three inches to six inches.

11. An apparatus as defined in claim 1, wherein said ink free apparatus is one of a laser and a printer head.

12. An apparatus as defined in claim 1, further including an air knife for blowing air onto the foodstuff after the food grade coloring has been applied by said spray gun.

13. A method of marking a foodstuff with a mark comprising the steps of:
providing a foodstuff;
providing an ink free apparatus;
providing a spray gun capable of spraying a food grade coloring;
moving the foodstuff past said ink free apparatus;
using said ink free apparatus to etch a mark on said foodstuff;
moving the foodstuff past said spray gun; and
using the spray gun to spray food grade coloring on said mark.

14. A method as defined in claim 13, further including the steps of providing controller; and using said controller to control said ink free apparatus and said spray gun.

15. A method as defined in claim 14, further including the steps of providing a conveyor; placing said foodstuff onto said conveyor for moving said foodstuff past said ink free apparatus and said spray gun.

16. A method as defined in claim 15, further including the steps of providing a shaft encoder associated with said conveyor for recording the speed of said conveyor and outputting a signal to said controller regarding the speed of said conveyor.

17. A method as defined in claim 13, further including the step of inputting a desired mark into said controller.

18. A method as defined in claim 13, further including the steps of using said controller to determine a length of the mark etched on said foodstuff by said ink free apparatus and thereafter determine the length of time the spray gun needs to be fired to cover said mark, and firing said spray gun said predetermined time.

19. A method as defined in claim 18, further including the step of using said controller to determine when said mark on said foodstuff is under said spray gun.
